(19) United States
(12) Patent Application Publication
(10) Pub. No.: US 2020/0257993 A1
(43) Pub. Date: Aug. 13, 2020

(54) INFORMATION PROCESSING SYSTEM, INFORMATION PROCESSING APPARATUS, AND NON-TRANSITORY COMPUTER-READABLE MEDIUM

(71) Applicant: FUJITSU CLIENT COMPUTING LIMITED, Kanagawa (JP)

(72) Inventors: Yuichiro Ikeda, Kawasaki (JP); Masatoshi Kimura, Kawasaki (JP); Tomohiro Ishida, Kawasaki (JP); Kai Mihara, Kawasaki (JP)

(73) Assignee: FUJITSU CLIENT COMPUTING LIMITED, Kanagawa (JP)

(21) Appl. No.: 16/750,438

(22) Filed: Jan. 23, 2020

(30) Foreign Application Priority Data
Feb. 13, 2019 (JP) 2019-023894

(51) Int. Cl. G06N 5/04; G06F 9/38; G06F 9/48

(52) U.S. Cl. CPC G06N 5/04; G06F 9/48; G06F 9/3836; G06F 9/3861

(57) ABSTRACT

An information processing system includes: a failure detector, a first failure handling unit and a second failure handling unit. The failure detector detects any of inference processing apparatuses in which a failure has occurred. The first failure handling unit causes another inference processing apparatus other than the inference processing apparatus in which the failure has occurred to execute an inference process of the inference processing apparatus in which the failure has occurred. The second failure handling unit inputs a result of an inference process at a preceding stage of the inference processing apparatus in which the failure has occurred to the another inference processing apparatus and outputs an inference result that the another inference processing apparatus generates based on the input inference result to an inference processing apparatus at a subsequent stage of the inference processing apparatus in which the failure has occurred.

### CROSS-REFERENCE TO RELATED APPLICATIONS

This application is based upon and claims the benefit of priority from Japanese Patent Application No. 2019-023894, filed Feb. 13, 2019, the entire contents of which are incorporated herein by reference.

### FIELD

Embodiments described herein relate generally to an information processing system, an information processing apparatus, and a non-transitory computer readable medium.

### BACKGROUND

An inference processing apparatus having learned models generated by machine learning in advance may perform various inference processes using the learned models.

Concerning the inference processing, there is a pipeline processing type apparatus configuration in which a plurality of inference processing apparatuses are connected in parallel, and an inference process is performed by an inference processing apparatus at a subsequent stage using a result of an inference process performed by an inference processing apparatus at a preceding stage, for example.

However, in the apparatus configuration of a pipeline processing type described above, a series of inference processes is interrupted when a failure occurs in any stage among a plurality of stages of the inference processes, and thus an inference result as a final result cannot be output, lacking availability.

### SUMMARY

According to one aspect of the present disclosure, an information processing system includes inference processing apparatuses, a controller, a failure detector, a first failure handling unit, and a second failure handling unit. The controller causes the inference processing apparatuses to execute respective inference processes having different processing tasks and controls input and output of the inference processing apparatuses such that an inference processing apparatus at a subsequent stage performs an inference process using an inference result of an inference process performed by an inference processing apparatus at a preceding stage. The failure detector detects any of the inference processing apparatuses in which a failure has occurred. In a case where occurrence of a failure is detected by the failure detector, the first failure handling unit causes another inference processing apparatus other than the inference processing apparatus in which the failure has occurred to execute an inference process that has been executed by the inference processing apparatus in which the failure has occurred. The second failure handling unit inputs an inference result derived by an inference process at a preceding stage of the inference processing apparatus in which the failure has occurred to the another inference processing apparatus and outputting an inference result that the another inference processing apparatus generates based on the input inference result to an inference processing apparatus at a subsequent stage of the inference processing apparatus in which the failure has occurred.

According to another aspect of the present disclosure, an information processing apparatus is connectable to inference processing apparatuses and includes a controller, a failure detector, a first failure handling unit, and a second failure handling unit. The controller causes the inference processing apparatuses to execute respective inference processes having different processing tasks and controlling input and output of the inference processing apparatuses such that an inference processing apparatus at a subsequent stage performs an inference process using an inference result of an inference process performed by an inference processing apparatus at a preceding stage. The failure detector detects any of the inference processing apparatuses in which a failure has occurred. In a case where occurrence of a failure is detected by the failure detector, the first failure handling unit causes another inference processing apparatus other than the inference processing apparatus in which the failure has occurred to execute an inference process that has been executed by the inference processing apparatus in which the failure has occurred. The second failure handling unit inputs an inference result derived by an inference process at a preceding stage of the inference processing apparatus in which the failure has occurred to the another inference processing apparatus and outputs an inference result that the another inference processing apparatus generates based on the input inference result to an inference processing apparatus at a subsequent stage of the inference processing apparatus in which the failure has occurred.

According to another aspect of the present disclosure, a non-transitory computer readable medium stores programmed instructions, when executed by a computer of an information processing apparatus connectable to inference processing apparatuses, causing the computer to perform as a controller, a failure detector, a first failure handling unit, and a second failure handling unit. The controller causes the inference processing apparatuses to execute respective inference processes having different processing tasks and controls input and output of the inference processing apparatuses such that an inference processing apparatus at a subsequent stage performs an inference process using an inference result of an inference process performed by an inference processing apparatus at a preceding stage. The failure detector detects any of the inference processing apparatuses in which a failure has occurred. In a case where occurrence of a failure is detected by the failure detector, the first failure handling unit causes another inference processing apparatus other than the inference processing apparatus in which a failure has occurred to execute an inference process that has been executed by the inference processing apparatus in which the failure has occurred. The second failure handling unit inputs an inference result derived by an inference process at a preceding stage of the inference processing apparatus in which the failure has occurred to the another inference processing apparatus and outputs an inference result that the another inference processing apparatus generates based on the input inference result to an inference processing apparatus at a subsequent stage of the inference processing apparatus in which the failure has occurred.

### BRIEF DESCRIPTION OF THE DRAWINGS

FIG. 1 is a diagram of an exemplary hardware configuration of an information processing system according to an embodiment;

FIG. 2 is a diagram of exemplary functional components of an information processing apparatus and an inference processing apparatus according to the embodiment;

FIG. 3 is a diagram of an exemplary data format of an intermediate result according to the embodiment;

FIG. 4 is a flowchart of an exemplary failure handling processing executed by a failure handling processing unit of the embodiment;

FIG. 5 is a schematic diagram of an exemplary input/output state in a case of normal operation of the information processing system according to the embodiment;

FIG. 6 is a schematic diagram of an exemplary input/output state in a case of failure occurrence in the information processing system according to the embodiment;

FIG. 7 is a schematic diagram of an exemplary input/output state in a case of normal operation of the information processing system according to a first modification;

FIG. 8 is a schematic diagram of an exemplary input/output state in a case of failure occurrence in the information processing system according to the first modification;

FIG. 9 is a schematic diagram of an exemplary input/output state in a case of normal operation of the information processing system according to a second modification; and

FIG. 10 is a schematic diagram of an exemplary input/output state in a case of failure occurrence in the information processing system according to the second modification.

### DETAILED DESCRIPTION

The following describes embodiments of an information processing system, an information processing apparatus, and a non-transitory computer-readable medium in detail with reference to the accompanying drawings. These embodiments do not limit the disclosed technique. Components having the same function in the embodiments are denoted by the same symbols, and a duplicated description will be omitted.

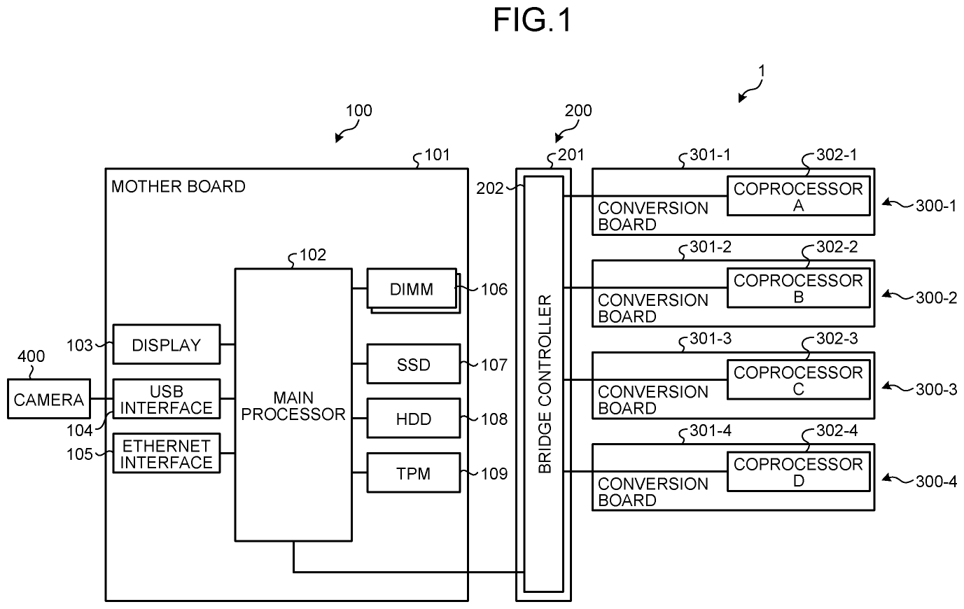

FIG. 1 is a diagram of an exemplary hardware configuration of an information processing system 1 according to an embodiment. As illustrated in FIG. 1, the information processing system 1 has an information processing apparatus 100, a relay apparatus 200, and inference processing apparatuses 300-1 to 300-4. The inference processing apparatuses 300-1 to 300-3 are active inference processing apparatuses used in normal operation and execute inference processing and the like described below. On the other hand, the inference processing apparatus 300-4 is a standby inference processing apparatus that is not used in normal operation. In the following, the active inference processing apparatuses 300-1 to 300-3 may be collectively denoted as an inference processing apparatus 300. Similarly, conversion boards 301-1 to 301-4, coprocessors 302-1 to 302-4, model files 304-1 to 304-3, and the like described below may also collectively be denoted.

The information processing apparatus 100 has a mother board 101, a main processor 102, a display 103, a universal serial bus (USB) interface 104, an Ethernet (registered trademark) interface 105, a dual inline memory module (DIMM) 106, a solid state drive (SSD) 107, a hard disk drive (HDD) 108, and a trusted platform module (TPM) 109.

The mother board 101 is a board on which components used to perform main functions of the information processing apparatus 100 are mounted. The main processor 102 is a processor performing the main functions of the information processing apparatus 100. Examples of the main processor 102 include electronic circuits such as a central processing unit (CPU) and a micro processing unit (MPU). The display 103 functions as a display unit displaying various kinds of information.

A USB device can be connected to the USB interface 104, which can mediate communication between the USB device and the main processor 102. In the information processing system 1 of the present embodiment, a camera 400 as an exemplary USB device is connected to the USB interface 104. Image data (hereinafter, a camera image) taken by the camera 400 is input to the information processing apparatus 100 via the USB interface 104.

An Ethernet cable can be connected to the Ethernet interface 105, which can mediate communication between an external device and the main processor 102 via the Ethernet cable. The DIMM 106 is a volatile storage medium such as a random access memory (RAM) that can temporarily store therein various kinds of information. The SSD 107 and the HDD 108 are non-volatile storage media that can store therein various kinds of information even after a power supply is shut off. The SSD 107 and the HDD 108 store therein various kinds of information, such as various kinds of computer programs executed by the main processor 102 and the model file 304 and inference processing connection setting information D1 described below. The TPM 109 is a module implementing security functions of the system.

The relay apparatus 200 has a bridge board 201 and a bridge controller 202. The bridge board 201 is a board which includes a bus (e.g., an expansion bus) or an I/O interface, such as a PCI Express (PCIe) bus or I/O interface, for example, and on which the bridge controller 202 is mounted. The bridge controller 202 provides bridge connections of a plurality of inference processing apparatuses 300 to the information processing apparatus 100 to mediate (relay) communication between the information processing apparatus 100 and the inference processing apparatuses 300.

The inference processing apparatuses 300-1 to 300-4 are connected to the relay apparatus 200 in parallel with each other. The inference processing apparatuses 300-1 to 300-4 have the conversion boards 301-1 to 301-4, respectively, and the coprocessors 302-1 to 302-4, respectively. The conversion board 301 is also called an accelerator board and is a board on which hardware used additionally in order to increase the processing ability of the information processing system 1 is mounted.

The coprocessor 302 is a processor suitable for arithmetic processing such as artificial intelligence (AI) inference processing and image processing. Examples of the coprocessor 302 include accelerators such as a graphics processing unit (GPU) and a dedicated chip. The coprocessor 302 may be a combination of a CPU and a GPU.

The AI inference processing is inference processing using artificial intelligence (AI) and includes inference processing by an inference model using a multilayered neural network (a hierarchical neural network). The inference processing apparatuses 300 store, in the non-volatile storage medium such as the SSD 107, the model files 304-1 to 304-3 which are learned inference models generated by performing machine learning on inference models using a hierarchical neural network. The coprocessor 302 loads the model file 304 and executes an inference process based on the loaded model file 304.

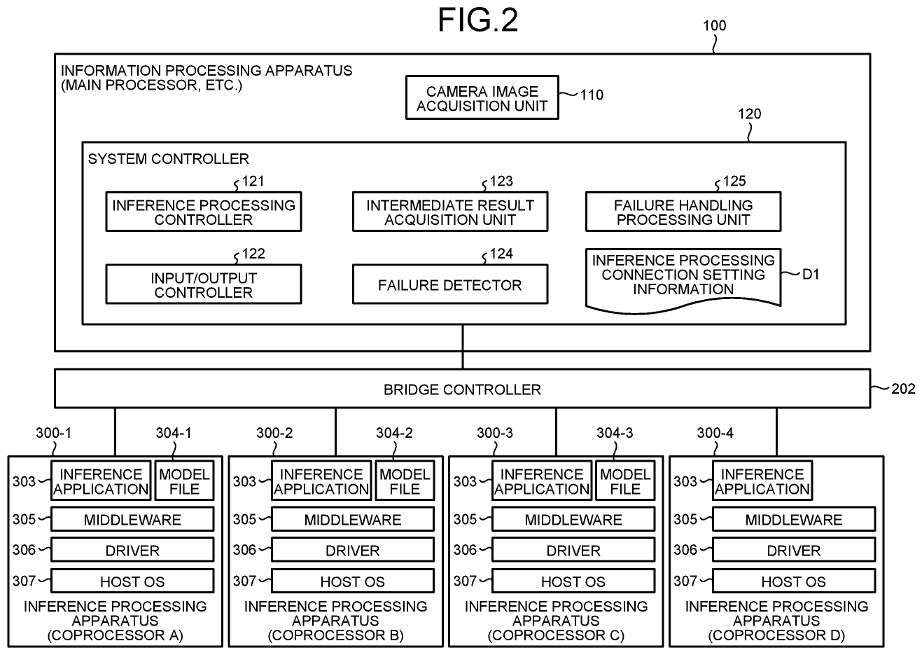

The following describes functional components of the information processing apparatus 100 and the inference processing apparatus 300 described above with reference to FIG. 2. FIG. 2 is a diagram of exemplary functional components of the information processing apparatus 100 and the inference processing apparatus 300.

The information processing apparatus 100 has a camera image acquisition unit 110 and a system controller 120 as the functional components. The functional components of the information processing apparatus 100 can be configured by functions executed within the main processor 102, for example.

The camera image acquisition unit 110 acquires a camera image taken by the camera 400. The camera image acquisition unit 110 temporarily stores the acquired camera image in a storage medium such as the DIMM 106.

The system controller 120 comprehensively controls operation of the inference processing apparatus 300. Specifically, the system controller 120 includes an inference processing controller 121, an input/output controller 122, an intermediate result acquisition unit 123, a failure detector 124, and a failure handling processing unit 125. The inference processing controller 121 and the input/output controller 122 are an example of a controller. The failure detector 124 is an example of a failure detector. The failure handling processing unit 125 is an example of a first failure handling unit and a second failure handling unit. These functional components may be software components implemented with the main processor 102 executing the computer programs stored in the SSD 107 or the HDD 108 or hardware components implemented by dedicated circuits or the like included in the main processor 102 or the like.

The inference processing controller 121 controls inference processes executed by the respective inference processing apparatuses 300. Specifically, the inference processing controller 121 reads the model files 304-1 to 304-3 from the storage medium such as the SSD 107 at the time of the start-up of the information processing system 1, for example, and loads the model files 304-1 to 304-3 to certain inference processing apparatuses 300 via the bridge controller 202.

The relation between the model files 304 and the respective inference processing apparatuses 300 as load destinations of the model files 304 is set in the inference processing connection setting information D1. In the present embodiment, for example, the inference processing connection setting information D1 has a setting in which a load destination of the model file 304-1 is the inference processing apparatus 300-1, a load destination of the model file 304-2 is the inference processing apparatus 300-2, and a load destination of the model file 304-3 is the inference processing apparatus 300-3.

The inference processing controller 121 loads each of the model files 304 to a corresponding inference processing apparatus 300 based on the setting details of the inference processing connection setting information D1. The system controller 120 may also load middleware 305 together with the model file 304 to the inference processing apparatus 300.

As illustrated in FIG. 2, the inference processing apparatuses 300 have an inference application 303, the model file 304, the middleware 305, a driver 306, and a host operating system (OS) 307.

The inference application 303 uses virtual environmental technique or the like and loads the model file 304 for which loading is instructed by the system controller 120. The inference application 303 initializes the model file 304 at the time of the start-up of the inference processing apparatus 300. The inference processing apparatus 300 (the coprocessor 302), in cooperation with the inference application 303, the middleware 305, and the like, executes a certain inference process using the loaded model file 304.

The model files 304-1 to 304-3 correspond to inference processes having different processing tasks. Specifically, the inference processes made executable by the loading of the model files 304-1 to 304-3 are sequentially executed so that an inference process executed at a subsequent stage outputs an inference result using an inference result output by an inference process executed at a preceding stage. Not all the processes are required to be different, and at least part of the inference processes may be different.

In a system detecting a human in the camera image and determining the age and gender of the human, for example, the model files 304-1 to 304-3 correspond to the following respective inference processes. First, the model file 304-1 corresponds to an inference process for extracting (inferring), from the camera image, a region in which a human is present (hereinafter, a human extraction inference process). The model file 304-2 corresponds to an inference process for inferring the age of the human from external features of the inferred human (hereinafter, an age inference process). The model file 304-3 corresponds to an inference process for inferring the gender of the human from the external features and the age of the inferred human (hereinafter, a gender inference process).

More specifically, in the human extraction inference process, upon input of the camera image and an image identifier identifying the camera image, the human shown in the camera image is recognized (inferred), then positional information indicating the position where the human is present (e.g., coordinates on the camera image) is derived. In the human extraction inference process, for each extracted human, an inference result, in which a human identifier identifying the human, the positional information of the human, the reliability of the inference result, and the like are associated with each other, is output together with the image identifier as a first inference result. In the human extraction inference process, the input camera image may be output together with the first inference result.

In the age inference process, upon input of the camera image and the first inference result, based on the positional information of each human indicated by the first inference result, the age of the human is inferred from the external features and the like of the human shown in the camera image. In the age inference process, for each human (each human identifier), an inference result, in which the inferred age, the reliability of the inference result, and the like are associated with each other, is output together with the image identifier and the first inference result as a second inference result. In the age inference process, the input camera image may be output together with the second inference result.

In the gender inference process, upon input of the camera image and the second inference result, based on the positional information and age of each human indicated by the second inference result, the gender of the human is inferred from the external features and the like of the human shown in the camera image. In the gender inference process, for each human (each human identifier), an inference result, in which the inferred gender, the reliability of the inference result, and the like are associated with each other, is output together with the image identifier and the second inference result. In this case, a third inference result output by the gender inference process is a final inference result of the series of inference processes. The gender inference process may output the input camera image together with the third inference result.

The input/output controller 122 controls input and output of each of the inference processing apparatuses 300. Specifically, the input/output controller 122 controls input and output of the inference processes executed by the respective inference processing apparatuses 300 based on the inference processing connection setting information D1.

In the case described above in which the age and gender of the human extracted from the camera image are inferred, for example, the input/output controller 122 sets an input destination of the camera image to the inference processing apparatus 300-1 (the human extraction inference process) as the load destination of the model file 304-1. The input/output controller 122 sets an output destination of the inference processing apparatus 300-1 (the human extraction inference process) to the inference processing apparatus 300-2 (the age inference process) that is the load destination of the model file 304-2. The input/output controller 122 sets an output destination of the inference processing apparatus 300-2 (the age inference process) to the inference processing apparatus 300-3 (the gender inference process) that is the load destination of the model file 304-3. The input/output controller 122 sets an output destination of the inference processing apparatus 300-3 (the gender inference process) to the system controller 120.

With this setting, the inference processing apparatuses 300-1 to 300-3 implement an inference processing system of a pipeline processing type in which an inference result is output by an inference process at a subsequent stage using an inference result output by an inference process at a preceding stage.

By the way, in the pipeline processing type configuration described above, when a failure occurs in any one stage of a plurality of inference processing stages (the inference processing apparatuses 300), the series of inference processes is interrupted, and thus the third inference result as the final result cannot be output, lacking availability.

Given these circumstances, when a failure occurs in any one of the inference processing apparatuses 300-1 to 300-3, the system controller 120 of the present embodiment causes the standby inference processing apparatus 300-4 to pursue the inference processing of the inference processing apparatuses 300 that has been interrupted by the failure occurrence.

Specifically, the system controller 120 implements the processing to cause the standby inference processing apparatus 300-4 to pursue the interrupted inference processing using the functions of the intermediate result acquisition unit 123, the failure detector 124, and the failure handling processing unit 125. The following describes the intermediate result acquisition unit 123, the failure detector 124, and the failure handling processing unit 125.

The intermediate result acquisition unit 123 acquires an inference result output by the inference process at each stage and temporarily stores the inference results as intermediate results in a storage such as the SSD 107. Specifically, the intermediate result acquisition unit 123 acquires the first inference result output from the inference processing apparatus 300-1 (the human extraction inference process) and the second inference result output from the inference processing apparatus 300-2 (the age inference process), and stores, in the storage, the first inference result and the second inference result that are the intermediate results.

The intermediate result includes an inference result derived by an inference process at each stage. The first inference result includes the human identifier identifying each human inferred (extracted) by the human extraction inference process, the positional information of the human in the camera image, and the reliability of the inference result, for example. The second inference result includes the age of each human inferred by the age inference process and the reliability of the inference result in addition to the contents of the first inference result. The first inference result and the second inference result are output in association with the image identifier identifying the processed common camera image.

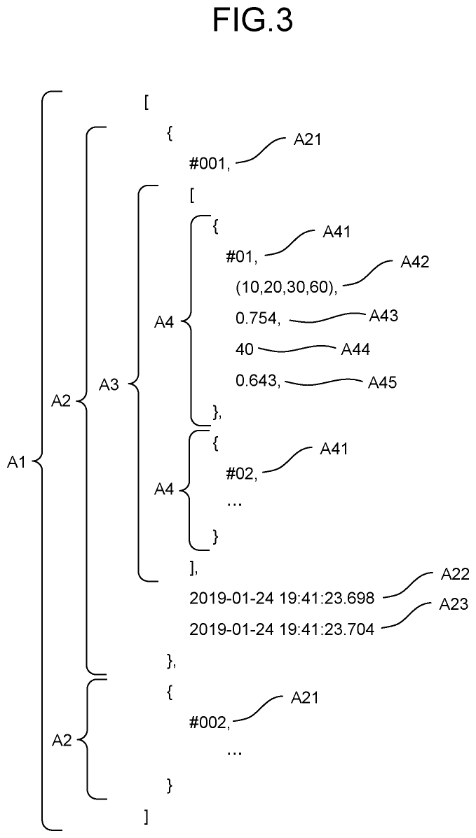

FIG. 3 is a diagram of an exemplary data format of the intermediate result. FIG. 3 shows an exemplary second inference result.

In FIG. 3, the intermediate result is recorded in an area A1 defined by the top and bottom square brackets “[]”. The area A1 includes one or more areas A2 defined by the curly brackets “{}”, and the intermediate result for each camera image is recoded within the area A2.

The area A2 includes an image identifier A21 (#001 or #002) for identifying the camera image. The area A2 includes an area A3 defined by the square brackets “[]”. The area A2 records a processing date and time A22 at which the inference processing apparatus 300 finishes its inference process and a reception date and time A23 at which the intermediate result acquisition unit 123 acquires this intermediate result. In the present example, the processing date and time A22 is a date and time at which the inference processing apparatus 300-2 finishes the age inference process.

The area A3 includes one or more areas A4 defined by the curly brackets “{}”. The area A4 is generated for each human extracted (inferred) from the camera image identified by the image identifier A21 and records the intermediate result (the inference result) for each human.

The area A4 records a human identifier A41 (e.g. #01 or #02) for identifying each extracted human. The area A4 records the contents of the first inference result and the second inference result inferred for the human identified by the human identifier A41. Specifically, the area A4 includes positional information A42 of the human and the reliability A43 thereof corresponding to the inference result (the first inference result) of the human extraction inference process. The area A4 also includes an age A44 of the human and the reliability A45 thereof corresponding to the inference result of the age inference process.

Thus, the intermediate result of the data format illustrated in FIG. 3 has a form in which the items related to the camera image and the human are recorded in a nested manner, and the second inference result contains the first inference result.

When the intermediate result is the first inference result, the items in the area A4 are the human identifier A41, the positional information A42, and the reliability A43, with the age A44 and the reliability A45 being null. In this case, the processing date and time A22 is a date and time at which the inference processing apparatus 300-1 finishes the human extraction inference process.

The final inference result (the third inference result) output by the inference process of the inference processing apparatus 300-3 (the gender inference process) may also be output in a format similar to the above-explained format. In this case, the third inference result is recorded in the area A4 for the corresponding human (the corresponding human identifier) while the third inference result contains the first inference result and the second inference result.

Although the data format shown in FIG. 3 describes an example in which the intermediate results from a plurality of camera images can collectively be recorded, the intermediate results may be recorded for each camera image. In this case, the area A1 includes a single area A2, for example.

Although the data format in FIG. 3 has a form in which the second inference result contains the first inference result, this is not limiting. The first inference result and the second inference result may be output as independent data. The third inference result may also be output as data independent of the first inference result and the second inference result. In this case, the first inference result to the third inference result each include the image identifier and the human identifier as common elements and include the inference result obtained in each inference process.

Referring back to FIG. 2, the failure detector 124 monitors the inference processing apparatuses 300-1 to 300-3 to detect an inference processing apparatus 300 in which a failure has occurred. The method for detecting a failure is not limited to a particular method. Various methods can be employed.

The failure detector 124 may detect the inference processing apparatus 300 in which a failure has occurred by receiving notification about failure occurrence from each of the inference processing apparatuses 300-1 to 300-3, for example. The failure detector 124 may detect the inference processing apparatus 300 based on the processing date and time recorded in the intermediate result, for example. In this case, when the failure detector 124 detects that an inference result is not output from a next stage inference processing apparatus 300 even after a lapse of a predetermined time (e.g., 1 minute) or more from the processing date and time recorded in the intermediate result, the failure detector 124 determines that a failure has occurred in the next stage inference processing apparatus 300.

When a failure is detected by the failure detector 124, the failure handling processing unit 125 executes failure handling processing for causing another inference processing apparatus other than the inference processing apparatus 300 in which a failure has occurred to pursue the inference process that has been executed by the inference processing apparatus 300 in which a failure has occurred.

Specifically, upon detection of the failure occurrence by the failure detector 124, the failure handling processing unit 125, in cooperation with the input/output controller 122, stops overall inference processing. The failure handling processing unit 125 sets an output destination of the camera image from the system controller 120 and output destinations of the inference processing apparatuses 300 to be null in order to stop the input and output of the inference processing apparatuses 300, for example.

The failure handling processing unit 125 identifies, based on the inference processing connection setting information D1, the inference processing apparatus 300 at the preceding stage of the inference processing apparatus 300 in which a failure has occurred. When occurrence of a failure in the inference processing apparatus 300-3 is detected, for example, the failure handling processing unit 125 identifies the inference processing apparatus 300-2 as a preceding stage inference processing apparatus 300 based on the order of the inference processes implemented by the loading of the model files 304.

Next, the failure handling processing unit 125, in cooperation with the inference processing controller 121, starts up the standby inference processing apparatus 300-4 as a new inference processing apparatus and then loads the model file 304 that has been loaded to the inference processing apparatus 300 in which a failure has occurred to the new inference processing apparatus. With this operation, the inference process corresponding to the loaded model file 304 is set in the new inference processing apparatus. The “new inference processing apparatus” is a concept corresponding to the “another inference processing apparatus” other than the inference processing apparatus 300 in which a failure has occurred.

Next, the failure handling processing unit 125 determines whether the intermediate result of the inference processing apparatus 300 at the preceding stage of the inference processing apparatus 300 in which a failure has occurred is stored. When the intermediate result is stored, the failure handling processing unit 125, in cooperation with the input/output controller 122, sets an input destination of the system controller 120 to the new inference processing apparatus and sets an output destination of the new inference processing apparatus to the inference processing apparatus 300 at the subsequent stage of the inference processing apparatus 300 in which a failure has occurred.

When the inference processing apparatus 300 in which a failure has occurred is a last stage inference processing apparatus 300 (the inference processing apparatus 300-3 in the present embodiment), the output destination of the new inference processing apparatus is set to the system controller 120.

Next, the failure handling processing unit 125 transmits (inputs) the camera image (the image identifier) and the corresponding intermediate result to the new inference processing apparatus. The new inference processing apparatus executes the inference process in response to the input of the camera image and the intermediate result and outputs its inference result to the subsequent stage inference processing apparatus 300 or the system controller 120. The failure handling processing unit 125 resumes the input and output of the inference processing apparatuses 300 at the stage or stages following the new inference processing apparatus. With this operation, the system controller 120 can acquire the final result (the third inference result) of the inference processing that has been interrupted by the failure occurrence.

Next, in order to process the next and subsequent camera images, the failure handling processing unit 125 updates an input/output setting such that the series of inference processes can be executed by the whole of the inference processing apparatuses 300 including the new inference processing apparatus. Specifically, the failure handling processing unit 125 sets an output destination of the inference processing apparatus 300 at the preceding stage of the inference processing apparatus 300 in which a failure has occurred to the new inference processing apparatus. Furthermore, the failure handling processing unit 125 sets the output destination of the new inference processing apparatus to the inference processing apparatus 300 at the subsequent stage of the inference processing apparatus 300 in which a failure has occurred. The failure handling processing unit 125 sets the input destination of the camera image (the image identifier) to the load destination of the model file 304-1. Then, the failure handling processing unit 125 updates the inference processing connection setting information to correspond to the updated connection state.

When the inference processing apparatus 300 in which a failure has occurred is the inference processing apparatus 300-1, the failure handling processing unit 125 sets the input destination of the camera image (the image identifier) to the new inference processing apparatus.

Next, the failure handling processing unit 125, in cooperation with the input/output controller 122, resumes the overall inference processes with the input and output paths based on the updated inference processing connection setting information.

Thus, upon occurrence of a failure in any of the inference processing apparatuses 300, the failure handling processing unit 125 sets the inference process that has been performed by the inference processing apparatus 300 in which a failure has occurred to the new inference processing apparatus. The failure handling processing unit 125 allows the inference processing apparatuses 300 to pursue the interrupted inference processes by inputting the inference result (the intermediate result) derived by the inference processing apparatus 300 at the preceding stage of the inference processing apparatus 300 in which a failure has occurred to the new inference processing apparatus. Upon completion of the inference processing that has been interrupted, the failure handling processing unit 125 updates the input and output of the overall inference processes to set the new inference processing apparatus as an active inference processing apparatus 300.

The failure handling processing unit 125 may delete the intermediate result related to the processed camera image (the image identifier) upon the completion of the inference processing by the new inference processing apparatus.

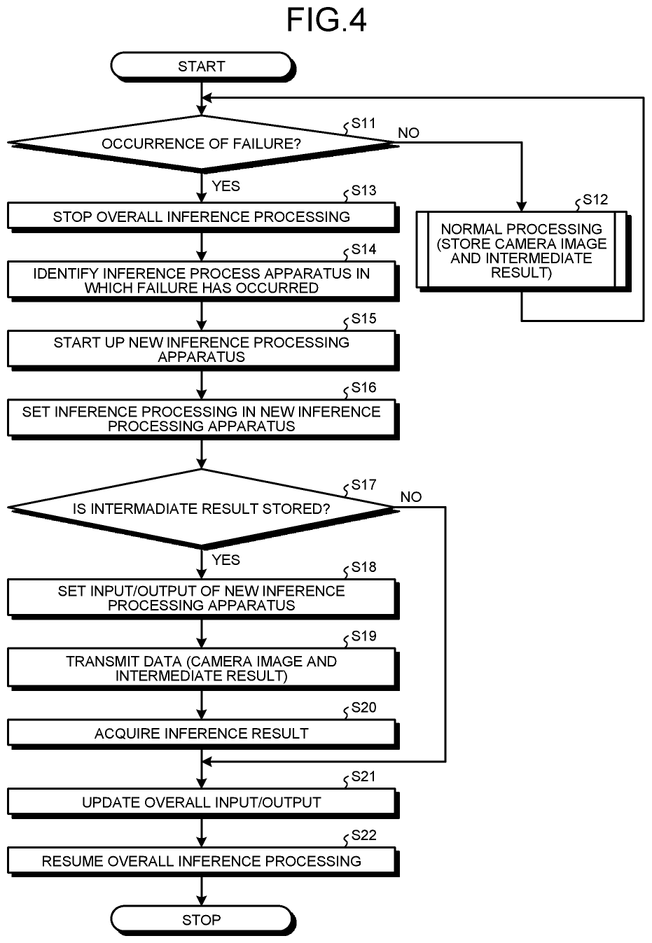

The following describes operation of the above-explained failure handling processing unit 125 with reference to FIG. 4. FIG. 4 is a flowchart of exemplary failure handling processing executed by the failure handling processing unit 125.

First, the failure handling processing unit 125 determines whether occurrence of a failure in any of the inference processing apparatuses 300 is detected by the failure detector 124 (Step S11). If the failure occurrence is not detected (No at Step S11), the normal inference processing (in which the camera image acquisition unit 110 stores the camera image and the intermediate result acquisition unit 123 stores the intermediate results) is performed by the active inference processing apparatuses 300 (step S12).

Upon detection of the failure occurrence at Step S11 (Yes at Step S11), the failure handling processing unit 125, in cooperation with the input/output controller 122, stops the overall inference processing (Step S13).

Subsequently, the failure handling processing unit 125 identifies, based on the inference processing connection setting information D1, the inference processing apparatus 300 in which a failure has occurred and the inference processing apparatus 300 at the preceding stage of the inference processing apparatus 300 in which a failure has occurred (Step S14). Next, the failure handling processing unit 125 starts up the new inference processing apparatus (the inference processing apparatus 300-4) (Step S15) and then, in cooperation with the inference processing controller 121, sets the inference process that has been executed by the inference processing apparatus 300 in which a failure has occurred to the new inference processing apparatus (Step S16).

Subsequently, the failure handling processing unit 125 determines whether the intermediate result of the inference processing apparatus 300 at the preceding stage of the inference processing apparatus 300 in which a failure has occurred is stored (Step S17). If the intermediate result is stored (Yes at Step S17), the failure handling processing unit 125, in cooperation with the input/output controller 122, sets input and output of the new inference processing apparatus (Step S18).

Subsequently, the failure handling processing unit 125 transmits (inputs) the camera image (the image identifier) and the intermediate result to the new inference processing apparatus (Step S19). The failure handling processing unit 125 then acquires the final result of the inference processing that has been interrupted (Step S20), and Step S21 is then performed. If it is determined that the intermediate result is not stored at Step S17 (No at Step S17), then Step S21 is performed.

At subsequent Step S21, the failure handling processing unit 125 updates the input/output setting such that the series of inference processes can be executed by the whole of the inference processing apparatuses 300 including the new inference processing apparatus and applies the updated input/output setting to the new inference processing apparatus (Step S21).

The failure handling processing unit 125 then, in cooperation with the input/output controller 122, resumes the overall inference processing with the input and output paths based on the updated inference processing connection setting information (Step S22) and ends the present processing.

Thus, upon occurrence of a failure in any of the inference processing apparatuses 300-1 to 300-3, the failure handling processing unit 125 causes the new inference processing apparatus to pursue the series of inference processes using the intermediate result obtained before the failure occurrence. With this operation, even when the inference processing is interrupted by the failure occurrence, the inference result as the final result can be output without abandoning the intermediate result, thus improving availability related to the inference processing.

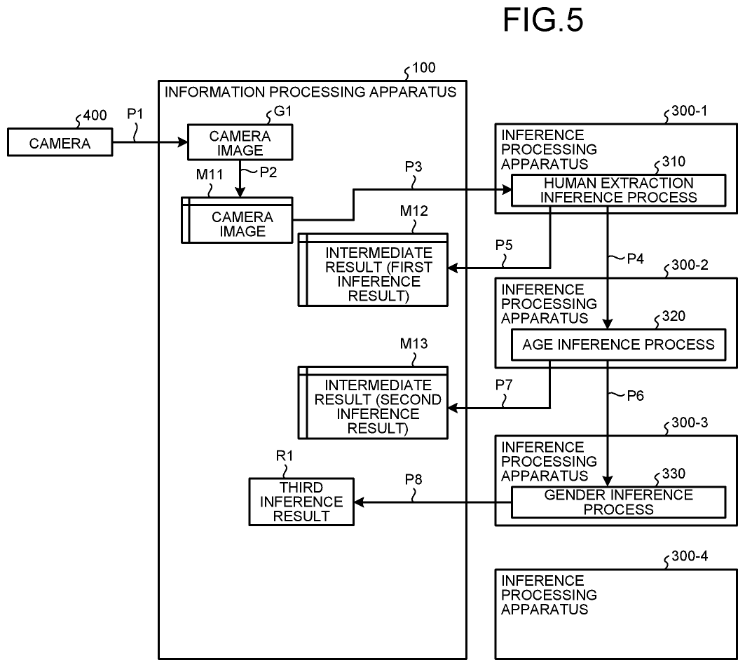

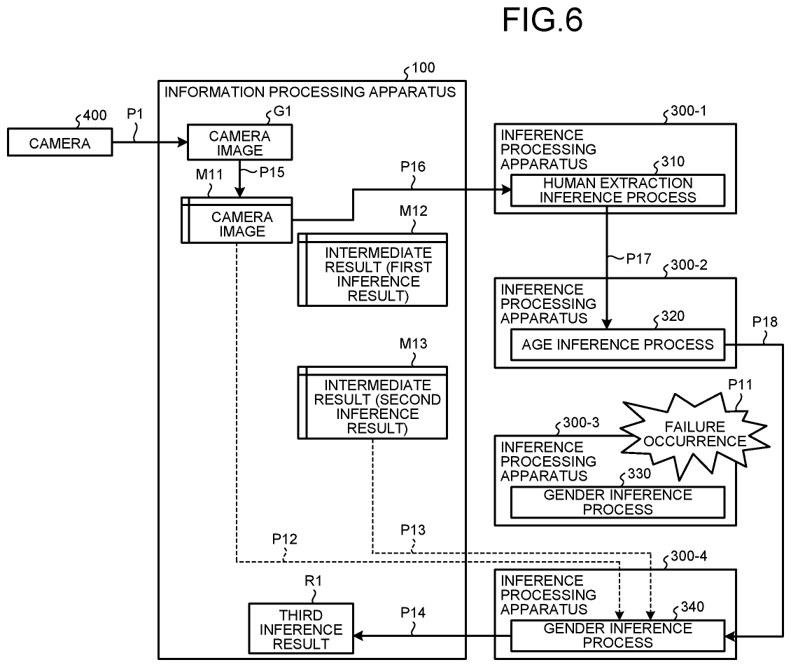

The following describes data input and output in the information processing system 1 with reference to FIG. 5 and FIG. 6. FIG. 5 is a schematic diagram of an exemplary input/output state in a case of normal operation of the information processing system 1. It is assumed that the inference processing apparatuses 300-1 to 300-3 have respective environment settings in which the human extraction inference process 310, the age inference process 320, and the gender inference process 330 can be executed using the model files 304-1 to 304-3 that have been loaded in advance, respectively.

First, an image is taken by the camera 400, then the camera image acquisition unit 110 acquires the taken camera image G1 (the symbol P1) and stores the camera image G1 in a storage medium M11 such as the SSD 107 (the symbol P2). Next, the system controller 120 reads the camera image G1 stored in the storage medium M11 and outputs the camera image G1 together with the image identifier to the inference processing apparatus 300-1 (the symbol P3).

In the inference processing apparatus 300-1, upon input of the camera image and the camera image identifier, the human extraction inference process 310 extracts (infers) a human shown in the camera image. The inference processing apparatus 300-1 sets an inference result of the human extraction inference process 310 and the camera image identifier in the first inference result and outputs the first inference result to the inference processing apparatus 300-2 together with the camera image (the symbol P4). The intermediate result acquisition unit 123 acquires the first inference result and stores the first inference result as the intermediate result in a storage medium M12 such as the SSD 107 (the symbol P5).

In the inference processing apparatus 300-2, upon input of the camera image and the first inference result from the inference processing apparatus 300-1, the age inference process 320 infers the age of the human shown in the camera image. The inference processing apparatus 300-2 sets an inference result of the age inference process 320 and the first inference result in the second inference result and outputs the second inference result to the inference processing apparatus 300-3 together with the camera image (the symbol P6). The intermediate result acquisition unit 123 acquires the second inference result of the age inference process 320 and stores the second inference result as the intermediate result in a storage medium M13 such as the SSD 107 (the symbol P7). The storage media M11, M12, and M13 may be the same storage or different storages. The storage media M12 and M13 are an example of a storing unit.

In the inference processing apparatus 300-3, upon input of the camera image, the camera image identifier, the first inference result, and the second inference result from the inference processing apparatus 300-2, the gender inference process 330 infers the gender of the human shown in the camera image. The inference processing apparatus 300-3 sets an inference result of the gender inference process 330, the camera image identifier, and the second inference result in a third inference result R1 and outputs the third inference result R1 to the information processing apparatus 100 (the system controller 120) (the symbol P8).

The third inference result R1 is a final result of the series of inference processes. The system controller 120 displays the age and gender of each human together with a corresponding camera image or counts the number of humans by age and gender based on the acquired third inference result R1, for example. The inference processes are performed by the inference processing apparatuses 300-1 to 300-3 for each camera image G1.

When a failure occurs in the inference processing apparatus 300-3, for example, as illustrated in FIG. 6, the failure detector 124 detects the failure that has occurred in the inference processing apparatus 300-3 (the symbol P11). FIG. 6 is a schematic diagram of an exemplary input/output state in a case of failure occurrence in the information processing system 1. In this case, the failure handling processing unit 125 executes the following processing upon the detection of the failure occurrence.

First, the failure handling processing unit 125 stops overall inference processing. With this operation, the input and output of the inference processing apparatuses 300 shown in FIG. 5 temporarily stops. Next, the failure handling processing unit 125 sets the gender inference process 340 in the inference processing apparatus 300-4 by loading the model file 304-3 that has been loaded to the inference processing apparatus 300-3 to the inference processing apparatus 300-4 which becomes the new inference processing apparatus.

Subsequently, the failure handling processing unit 125 sets an output destination of the camera image stored in the storage medium M11 to the inference processing apparatus 300-4 (the symbol P12) and sets an output destination of the intermediate result of the inference processing apparatus 300-2 at the preceding stage of the inference processing apparatus 300-3 (the second inference result) to the inference processing apparatus 300-4 (the symbol P13). In addition, the failure handling processing unit 125 sets an output destination of the inference processing apparatus 300-4 to the information processing apparatus 100 (the system controller 120) (the symbol P14).

Next, the failure handling processing unit 125 starts to output (transmit) the camera image and the intermediate result (the second inference result) to input these data to the inference processing apparatus 300-2. With this operation, the third inference result R1 derived by the gender inference processing 340 of the inference processing apparatus 300-4 is output to the information processing apparatus 100.

Then, the failure handling processing unit 125 updates the input/output setting such that the series of inference processes can be executed by the whole of the inference processing apparatuses 300 including the new inference processing apparatus. FIG. 6 illustrates an example setting in which the camera image acquired by the camera image acquisition unit 110 is input to the inference processing apparatus 300-1 via the storage medium M11 (the symbols P15 and P16). FIG. 6 also illustrates an example in which an output destination of the inference processing apparatus 300-1 is the inference processing apparatus 300-2, whereas an output destination of the inference processing apparatus 300-2 is the inference processing apparatus 300-4 (the symbols P17 and P18). After the update of the input/output setting, the paths indicated by the broken lines of the symbol P12 and the symbol P13 become unused.

As described above, according to the present embodiment, even in a case where a failure occurs in any of the active inference processing apparatuses 300-1 to 300-3, the inference processing apparatus 300-4 can pursue the series of inference processes using the intermediate result obtained before the failure occurrence. With this operation, even in a case where the inference processing is interrupted by the failure occurrence, the inference result which is the final result can be output without abandoning the intermediate result, thus improving availability related to the inference processing.

In the present embodiment, the information processing system 1 includes the standby inference processing apparatus 300-4, and the failure handling processing unit 125 selects the standby inference processing apparatus 300-4 as another inference processing apparatus other than the inference processing apparatus 300 in which a failure has occurred. With this operation, even in a case where a failure occurs in any of the operating inference processing apparatuses 300-1 to 300-3, the inference processing can be pursued using the standby inference processing apparatus 300-4.

In the present embodiment, the failure handling processing unit 125 selects the standby inference processing apparatus 300-4 that has a low inference processing load, as the another inference processing apparatus other than the inference processing apparatus 300 in which a failure has occurred. With this operation, an increase in the efficiency of the inference processing and an increase in throughput can be achieved.

In the present embodiment, the information processing apparatus 100 (the system controller 120) includes the storing unit, such as the storage media M12 and M13, storing the inference results output from the respective inference processing apparatuses 300, and the failure handling processing unit 125 inputs, among the inference results stored by the storing unit, an inference result of the inference process that has been executed by the inference processing apparatus 300 at the preceding stage of the inference processing apparatus 300 in which a failure has occurred to the another inference processing apparatus (the inference processing apparatus 300-4). With this operation, the inference processing apparatus 300-4 can take over the inference result executed by the inference processing apparatus 300 at the preceding stage of the inference processing apparatus 300 in which a failure has occurred, and the inference result as the final result can be output without abandoning the intermediate result.

In the present embodiment, after the inference result of the another inference processing apparatus (the inference processing apparatus 300-4) is output, the failure handling processing unit 125 sets the output destination of the inference processing apparatus 300 at the preceding stage of the inference processing apparatus 300 in which a failure has occurred to the another inference processing apparatus (the inference processing apparatus 300-4). With this operation, the series of inference processes can continuously be executed by the whole of the inference processing apparatuses 300 including the inference processing apparatus 300-4.

The embodiment described above can also be implemented with appropriate modifications by modifying part of the components or functions of the information processing system 1. The following describes some modifications related to the embodiment as other embodiments. The following mainly describes points different from those of the above-described embodiment, and a detailed description will be omitted for points common to the above-described details. The modifications described below may be performed individually or performed in combination as appropriate.

First Modification

Although the embodiment in which the intermediate results output from the respective inference processing apparatuses 300 are stored in the information processing apparatus 100 is explained above, this is not limiting. In another embodiment, the inference processing apparatuses 300 store the intermediate results respectively. The following describes an embodiment of a first modification in which the inference processing apparatuses 300 store the intermediate results respectively.

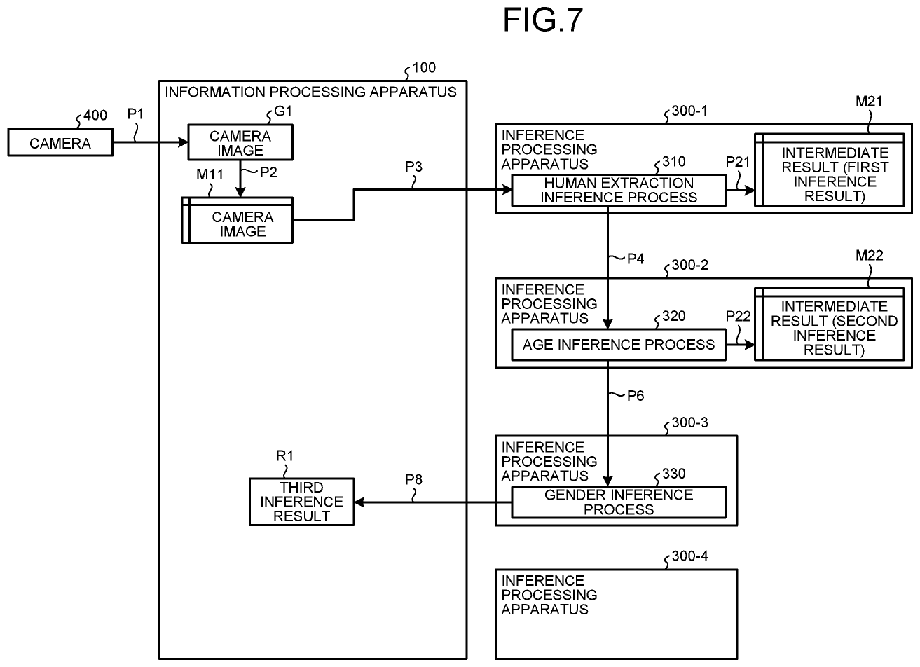

FIG. 7 is a schematic diagram of an exemplary input/output state in a case of normal operation of the information processing system 1 according to the present modification. As illustrated in FIG. 7, the configuration of the present modification is different from the embodiment in that each of the inference processing apparatus 300-1 and the inference processing apparatus 300-2 stores an inference result by itself.

Specifically, the inference processing apparatus 300-1 stores the first inference result by the human extraction inference process 310 as the intermediate result in its own storage medium M21 (the symbol P21). The inference processing apparatus 300-2 stores the second inference result by the age inference processing 320 as the intermediate result in its own storage medium M22 (the symbol P22). The storage media M21 and M22 are each an exemplary storing unit. Although the inference processing apparatus 300-3 does not include a storing unit in the present embodiment, the inference processing apparatus 300-3 may have a storing unit.

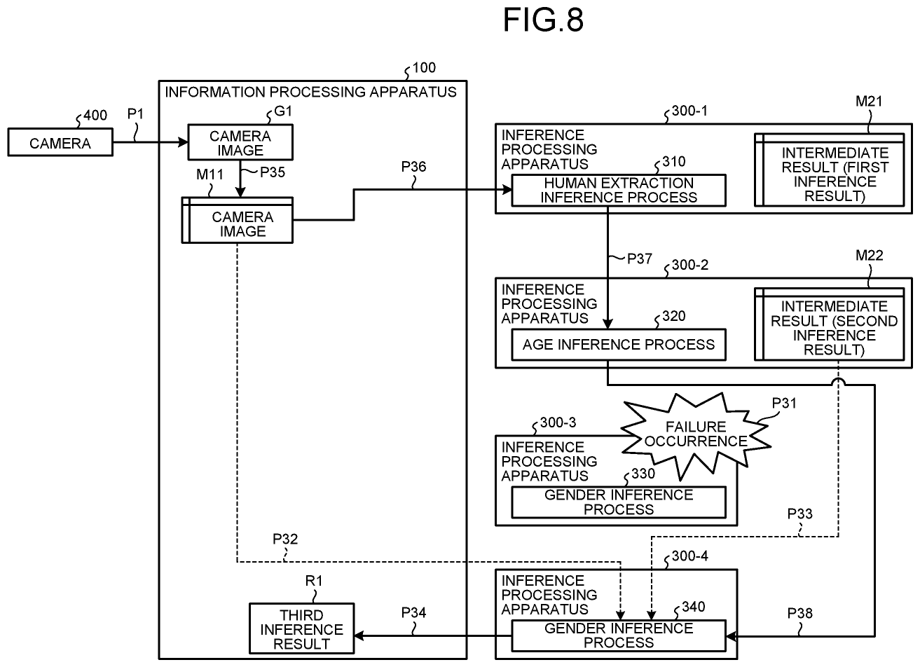

When a failure occurs in the inference processing apparatus 300-3, for example, as illustrated in FIG. 8, the failure detector 124 detects the failure that has occurred in the inference processing apparatus 300-3 (the symbol P31). FIG. 8 is a schematic diagram of an exemplary input/output state in a case of failure occurrence in the information processing system 1 according to the present modification. In this case, the failure handling processing unit 125 executes the following processing upon the detection of the failure occurrence.

First, the failure handling processing unit 125 stops overall inference processing. With this operation, the input and output of the inference processing apparatuses 300 shown in FIG. 7 temporarily stops. Next, the failure handling processing unit 125 sets the gender inference process 340 in the inference processing apparatus 300-4 by loading the model file 304-3 that has been loaded to the inference processing apparatus 300-3 to the inference processing apparatus 300-4 which becomes the new inference processing apparatus.

Subsequently, the failure handling processing unit 125 sets the output destination of the camera image stored in the storage medium M11 to the inference processing apparatus 300-4 (the symbol P32), and sets the output destination of the intermediate result (the second inference result) of the inference processing apparatus 300-2 at the preceding stage of the inference processing apparatus 300-3 to the inference processing apparatus 300-4 (the symbol P33). The failure handling processing unit 125 also sets the output destination of the inference processing apparatus 300-4 to the information processing apparatus 100 (the system controller 120) (the symbol P34).

Subsequently, the failure handling processing unit 125 starts to output (transmit) the camera image and the intermediate result (the second inference result) to input these data to the inference processing apparatus 300-4. With this operation, the third inference result R1 derived by the gender inference process 340 of the inference processing apparatus 300-4 is output to the information processing apparatus 100.

The failure handling processing unit 125 updates the input/output setting such that the series of inference processes can be executed by the whole of the inference processing apparatuses 300 including the new inference processing apparatus. FIG. 8 illustrates an example in which the camera image acquired by the camera image acquisition unit 110 is input to the inference processing apparatus 300-1 via the storage medium M11 (the symbols P35 and P36). FIG. 8 also illustrates an example in which the output destination of the inference processing apparatus 300-1 is the inference processing apparatus 300-2, whereas the output destination of the inference processing apparatus 300-2 is the inference processing apparatus 300-4 (the symbols P37 and P38).

As described above, the present modification can improve availability related to the inference processing like the above-described embodiment. In the present modification, since the intermediate result acquisition unit 123 is unnecessary the intermediate result acquisition unit 123 may be removed from the system controller 120 of the information processing apparatus 100.

In the present modification, each of the inference processing apparatuses 300 includes the storing unit, such as the storage medium M21 or M22, storing an inference result of its own inference process, and the failure handling processing unit 125 inputs an inference result stored by the inference processing apparatus 300 at the preceding stage of the inference processing apparatus 300 in which a failure has occurred to the another inference processing apparatus (the inference processing apparatus 300-4) other than the inference processing apparatus 300 in which a failure has occurred. With this operation, the inference processing apparatus 300-4 can take over the inference result executed by the inference processing apparatus 300 at the preceding stage of the inference processing apparatus 300 in which a failure has occurred, and the inference result as the final result can be output without abandoning the intermediate result.

Second Modification

Although the embodiment in which the inference processing is pursued using the standby inference processing apparatus 300 as the new inference processing apparatus is explained above, this is not limiting. The inference processing may be pursued using the active inference processing apparatus 300. The following describes a second modification in which the active inference processing apparatus 300 pursues the inference processing.

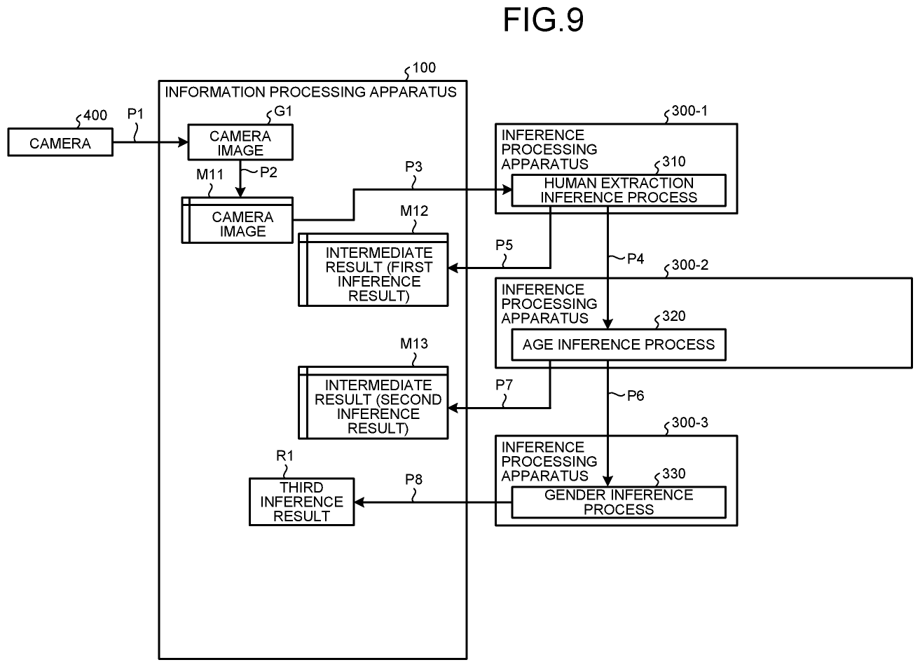

FIG. 9 is a schematic diagram of an exemplary input/output state in a case of normal operation of the information processing system 1 according to the present modification. As illustrated in FIG. 9, in the configuration of the present modification, the standby inference processing apparatus 300-4 is removed from the configuration of the above-described embodiment. The inference processing apparatuses 300-1 to 300-3 are all active inference processing apparatuses 300.

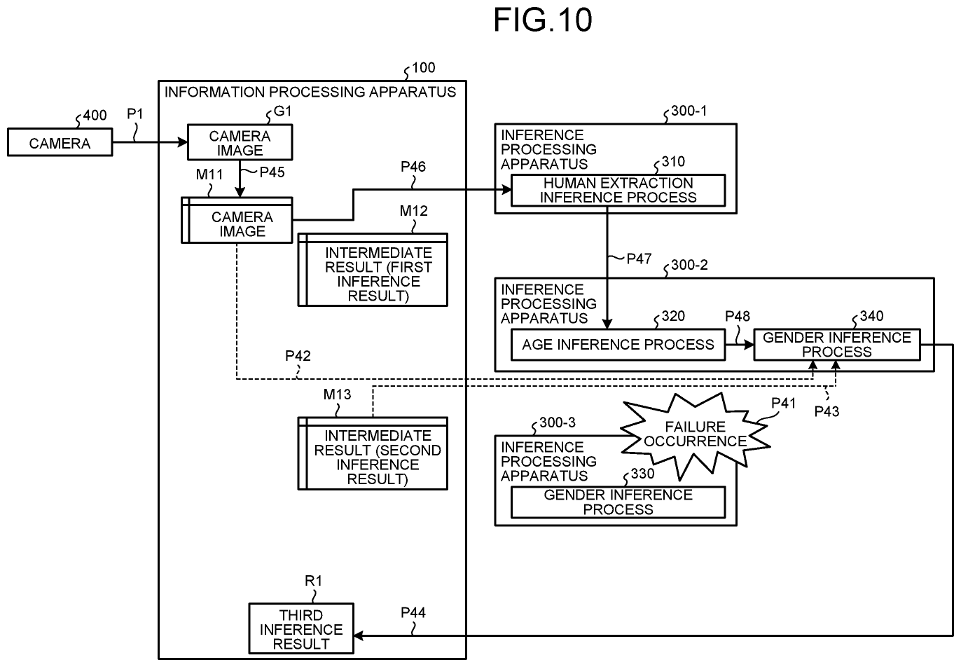

In the configuration shown in FIG. 9, when a failure occurs in the inference processing apparatus 300-3, for example, as illustrated in FIG. 10, the failure detector 124 detects the failure that has occurred in the inference processing apparatus 300-3 (the symbol P41). FIG. 10 is a schematic diagram of an exemplary input/output state in a case of failure occurrence in the information processing system 1 according to the present modification. In this case, the failure handling processing unit 125 executes the following processing upon the detection of the failure occurrence.

First, the failure handling processing unit 125 stops overall inference processing. With this operation, the input and output of the inference processing apparatuses 300 shown in FIG. 9 temporarily stops. Next, the failure handling processing unit 125 sets the gender inference process 340 in the new inference processing apparatus by loading the model file 304-3 that has been loaded to the inference processing apparatus 300-3 to any one of the normally workable inference processing apparatuses 300 which becomes the new inference processing apparatus.

While the new inference processing apparatus is not limited to a particular inference processing apparatus so long as it is an normally workable inference processing apparatus 300, it is efficient in terms of data input and output to select the inference processing apparatus 300 at the preceding stage or the subsequent stage of the inference processing apparatus 300 in which a failure has occurred. An increase in the efficiency of the inference processing and an increase in throughput can be achieved by selecting the inference processing apparatus 300 which has a lower load of the existing inference process as the new inference processing apparatus.

FIG. 10 illustrates an example in which the inference processing apparatus 300-2 at the preceding stage of the inference processing apparatus 300-3 in which a failure has occurred is selected as the new inference processing apparatus. Specifically, the failure handling processing unit 125 sets the gender inference process 340 in the inference processing apparatus 300-2 by loading the model file 304-3 that has been loaded to the inference processing apparatus 300-3 to the inference processing apparatus 300-2. With this operation, the inference processing apparatus 300-2 can execute the existing age inference process 320 and the newly set gender inference process 340.

Subsequently, the failure handling processing unit 125 sets the output destination of the camera image stored in the storage medium M11 to the inference processing apparatus 300-2 (the gender inference process 340) (the symbol P42) and sets the output destination of the intermediate result (the second inference result) of the inference processing apparatus 300-2 at the preceding stage of the inference processing apparatus 300-3 to the inference processing apparatus 300-2 (the gender inference process 340) (the symbol P43). The failure handling processing unit 125 sets the output destination of the inference processing apparatus 300-2 (the gender inference process 340) to the information processing apparatus 100 (the system controller 120) (the symbol P44).

Subsequently, the failure handling processing unit 125 starts to output (transmit) the camera image and the intermediate result (the second inference result) to input these data to the gender inference process 340 of the inference processing apparatus 300-2. With this operation, the third inference result R1 derived by the gender inference process 340 of the inference processing apparatus 300-2 is output to the information processing apparatus 100.

The failure handling processing unit 125 updates the input/output setting such that the series of inference processes can be executed by the whole of the inference processing apparatuses 300 including the new inference processing apparatus. FIG. 10 illustrates an example in which the camera image acquired by the camera image acquisition unit 110 is input to the inference processing apparatus 300-1 via the storage medium M11 (the symbols P45 and P46). FIG. 10 also illustrates an example in which the output destination of the inference processing apparatus 300-1 is the age inference processing 320 of the inference processing apparatus 300-2, whereas an output destination of the age inference process 320 is the gender inference process 340 of the inference processing apparatus 300-2 (the symbols P47 and P48).

As described above, the present modification can improve availability related to the inference processing like the above-described embodiment.

In the present modification, the failure handling processing unit 125 selects the inference processing apparatus 300 at the preceding stage or the subsequent stage of the inference processing apparatus 300 in which a failure has occurred as the another inference processing apparatus other than the inference processing apparatus 300 in which a failure has occurred, and causes the selected another inference processing apparatus to execute the inference process that has been executed by the inference processing apparatus 300 in which a failure has occurred. With this operation, the update of the input/output setting executed at the time of failure occurrence can be efficiently performed.

In the present modification, the failure handling processing unit 125 selects the inference processing apparatus 300 having a lower inference processing load as the another inference processing apparatus. With this operation, an increase in the efficiency of the inference processing and an increase in throughput can be achieved.

Third Modification

Although the number of stages of the active inference processing apparatuses 300, that is, the number of stages of the series of inference processes is three in the above-described embodiments, the number of stages is not limited to a particular number so long as a plurality of stages are provided. Although the number of the standby inference processing apparatus 300 is one in the above-described embodiments, this is not limiting. A plurality of standby inference processing apparatuses 300 may be provided.

Fourth Modification

Although an example in which a plurality of inference processing apparatuses 300 sequentially perform the inference processes is explained in the above-described embodiments, this is not limiting. Part of the inference processing apparatuses 300 may perform the inference processes in parallel. In the configuration of the inference processing apparatuses 300 in the above-described embodiment, the inference processing apparatus 300-2 and the inference processing apparatus 300-3 may perform inference on age and gender in parallel after the inference processing apparatus 300-2 and the inference processing apparatus 300-3 receive the first inference result of the inference processing apparatus 300-1, for example. In this case, using the technique of the embodiment or the modifications, even in a case that the inference processing is interrupted by failure occurrence, the interrupted inference processing can be continuingly executed by using the technique of the embodiment or the modifications.

Fifth Modification

In the above-described embodiments, explained is a configuration in which the inference processing apparatuses 300 are each an individual apparatus, whereby the entire information processing system 1 is defined as a system. However, the entire information processing system 1 can also be defined as a single information processing apparatus in a case that the information processing system 1 is viewed with each of the inference processing apparatuses 300 provided as a peripheral, an expansion card, or the like of the information processing apparatus 100.

Although the embodiment exemplifies PCIe as the bus (e.g., an expansion bus) or the I/O interface of each part, the bus or the I/O interface is not limited to PCIe. The bus or the I/O interface of each part may use any technique that enables data transfer between a device (a peripheral controller) and a processor with a data transfer bus, for example. The data transfer bus may be a universal bus that can transfer data at high speed in a local environment provided in one casing or the like (e.g., a single system or a single apparatus). The I/O interface may be either a parallel interface or a serial interface.

The I/O interface, in serial transfer, may be a configuration that can provide a point-to-point connection and transfer data on a packet basis. The I/O interface, in serial transfer, may have a plurality of lanes. The layer structure of the I/O interface may have a transaction layer performing generation and decoding of packets, a data link layer performing error detection and the like, and a physical layer converting between serial and parallel. The I/O interface may include a root complex residing at the top of the hierarchy and having one or a plurality of ports, an endpoint which is an I/O device, a switch for increasing the number of ports, and a bridge for converting protocols. The I/O interface may multiplex data to be transmitted and a clock signal by a multiplexer and transmit the multiplexed data and clock signal. In this case, a reception side may separate the data and the clock signal from each other by a demultiplexer.

According to one aspect, it is possible to provide an information processing system, an information processing apparatus, and a non-transitory computer readable medium which are capable of improving availability related to the inference processing.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing system comprising:
inference processing apparatuses;
a controller that causes the inference processing apparatuses to execute respective inference processes having different processing tasks and that controls input and output of the inference processing apparatuses such that an inference processing apparatus at a subsequent stage performs an inference process using an inference result of an inference process performed by an inference processing apparatus at a preceding stage;
a failure detector that detects any of the inference processing apparatuses in which a failure has occurred;
a first failure handling unit, when the failure is detected by the failure detector, that causes another inference processing apparatus other than the inference processing apparatus in which the failure has occurred to execute an inference process that has been executed by the inference processing apparatus in which the failure has occurred; and
a second failure handling unit that inputs an inference result derived by an inference process at a preceding stage of the inference processing apparatus in which the failure has occurred to the another inference processing apparatus and that outputs an inference result that the another inference processing apparatus generates based on the input inference result to an inference processing apparatus at a subsequent stage of the inference processing apparatus in which the failure has occurred.

2. The information processing system according to claim 1, wherein
the inference processing apparatuses include a standby inference processing apparatus, and
the first failure handling unit selects the standby inference processing apparatus as the another inference processing apparatus.

3. The information processing system according to claim 1, wherein the first failure handling unit selects an inference processing apparatus at a preceding stage or a subsequent stage of the inference processing apparatus in which the failure has occurred as the another inference processing apparatus.

4. The information processing system according to claim 1, wherein the first failure handling unit selects an inference processing apparatus having a low inference processing load among the inference processing apparatuses other than the inference processing apparatus in which the failure has occurred as the another inference processing apparatus.

5. The information processing system according to claim 1, further comprising a storing unit that stores inference results output from the respective inference processing apparatuses, and
wherein the second failure handling unit inputs, among the inference results stored in the storing unit, an inference result of an inference process that has been executed by the inference processing apparatus at a preceding stage of the inference processing apparatus in which the failure has occurred to the another inference processing apparatus.

6. The information processing system according to claim 1, wherein
each of the inference processing apparatuses includes a storing unit that stores an inference result of its own inference process, and
the second failure handling unit inputs an inference result stored in the inference processing apparatus at a preceding stage of the inference processing apparatus in which the failure has occurred to the another inference processing apparatus.

7. The information processing system according to claim 1, wherein after the inference result of the another inference processing is output, the second failure handling unit sets an output destination of the inference processing apparatus at a preceding stage of the inference processing apparatus in which the failure has occurred to the another inference processing apparatus.

8. An information processing apparatus connectable to inference processing apparatuses, the information processing apparatus comprising:
a controller that causes the inference processing apparatuses to execute respective inference processes having different processing tasks and that controls input and output of the inference processing apparatuses such that an inference processing apparatus at a subsequent stage performs an inference process using an inference result of an inference process performed by an inference processing apparatus at a preceding stage;
a failure detector that detects any of the inference processing apparatuses in which a failure has occurred;
a first failure handling unit, when the failure is detected by the failure detector, that causes another inference processing apparatus other than the inference processing apparatus in which the failure has occurred to execute an inference process that has been executed by the inference processing apparatus in which the failure has occurred; and
a second failure handling unit that inputs an inference result derived by an inference process at a preceding stage of the inference processing apparatus in which the failure has occurred to the another inference processing apparatus and that outputs an inference result that the another inference processing apparatus generates based on the input inference result to an inference processing apparatus at a subsequent stage of the inference processing apparatus in which the failure has occurred.

9. A non-transitory computer readable medium that stores programmed instructions that when executed by a computer of an information processing apparatus connectable to inference processing apparatuses causes the computer to perform as:
a controller that causes the inference processing apparatuses to execute respective inference processes that has different processing tasks and that controls input and output of the inference processing apparatuses such that an inference processing apparatus at a subsequent stage performs an inference process that uses an inference result of an inference process performed by an inference processing apparatus at a preceding stage;
a failure detector that detects any of the inference processing apparatuses in which a failure has occurred;
a first failure handling unit, when the failure is detected by the failure detector, that causes another inference processing apparatus other than the inference processing apparatus in which a failure has occurred to execute an inference process that has been executed by the inference processing apparatus in which the failure has occurred; and
a second failure handling unit that inputs an inference result derived by an inference process at a preceding stage of the inference processing apparatus in which the failure has occurred to the another inference processing apparatus and that outputs an inference result that the another inference processing apparatus generates based on the input inference result to an inference processing apparatus at a subsequent stage of the inference processing apparatus in which the failure has occurred.
